(19) United States
(12) Patent Application Publication
(10) Pub. No.: US 2019/0294731 A1
(43) Pub. Date: Sep. 26, 2019

(54) SEARCH QUERY DISPATCHER USING MACHINE LEARNING

(71) Applicant: Microsoft Technology Licensing, LLC, Redmond, WA (US)

(72) Inventors: Huiji Gao, Sunnyvale, CA (US); Lei Li, Sunnyvale, CA (US); Zimeng Yang, Sunnyvale, CA (US)

(21) Appl. No.: 15/936,261

(22) Filed: Mar. 26, 2018

(51) Int. Cl. G06F 17/30; G06N 99/00

(52) U.S. Cl. CPC G06F 17/30864; G06F 17/30979; G06N 99/005

(57) ABSTRACT

Techniques for implementing a search query dispatcher using machine learning are disclosed herein. In some embodiments, a method comprises: receiving a search query comprising at least one term entered by a user via a computing device; determining a search intention for the search query based on the term(s) of the search query, the determining comprising determining the search intention to be either a single-target search intention to find a specific single result or multiple-target search intention to find multiple results having at least one common characteristic; selecting a search intention model for the search query from amongst a plurality of distinct search intention models based on the determined search intention, the plurality of distinct search intention models comprising a single-target search model for the single-target search intention and a multiple-target search model for the multiple-target search intention; and generating search results using the selected search intention model.

### TECHNICAL FIELD

The present application relates generally to generative adversarial networks and, in one specific example, to methods and systems of implementing a search query dispatcher using machine learning.

### BACKGROUND

Current search query systems of online services suffer from a lack of personalization, relevance, accuracy, and completeness when generating search results in response to a search query submitted by a user of the online service, resulting in the most relevant content being downgraded in favor of irrelevant content in the search results. Additionally, since otherwise relevant search results are omitted or otherwise downgraded, users often spend a longer time on their search, consuming electronic resources (e.g., network bandwidth, computational expense of server performing search). Other technical problems can arise as well. These problems arise in part because of detrimental biases that exist in the search models and architectures employed by current search query systems, such as search intention bias, user behavior bias, ranking bias, and search model bias.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a search query system, in accordance with an example embodiment.

FIG. 4 is a block diagram illustrating a data flow, in accordance with an example embodiment.

FIG. 5 is a flowchart illustrating a method of implementing a search query dispatcher using machine learning, in accordance with an example embodiment.

FIG. 6 is a flowchart illustrating a method of determining a search intention for a search query, in accordance with an example embodiment.

FIG. 7 is a flowchart illustrating another method of implementing a search query dispatcher using machine learning, in accordance with an example embodiment.

FIG. 8 is a flowchart illustrating a method of generating search results for a search query, in accordance with an example embodiment.

FIG. 9 is a flowchart illustrating another method of generating search results for a search query, in accordance with an example embodiment.

FIG. 10 is a flowchart illustrating yet another method of generating search results for a search query, in accordance with an example embodiment.

FIG. 11 is a block diagram illustrating a mobile device, in accordance with some example embodiments.

FIG. 12 is a block diagram of an example computer system on which methodologies described herein may be executed, in accordance with an example embodiment.

### DETAILED DESCRIPTION

Example methods and systems of implementing a search query dispatcher using machine learning are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to address the detrimental biases in search models and architectures by implementing a search query dispatcher using machine learning. Additionally, other technical effects will be apparent from this disclosure as well. Although some example embodiments disclosed herein involve use cases for social networking services, it is contemplated that the features disclosed herein may be used with other types of online services as well.

In some example embodiments, operations are performed by a computer system (or other machine) having a memory and at least one hardware processor, with the operations comprising: receiving a search query from a computing device of a user, the search query comprising at least one term entered by the user via a user interface of the computing device; determining a search intention for the search query based on the term(s) of the search query, the determining comprising determining the search intention to be either a single-target search intention to find a specific single result or multiple-target search intention to find multiple results having at least one common characteristic; selecting a search intention model for the search query from amongst a plurality of distinct search intention models based on the determined search intention of the search query, the plurality of distinct search intention models comprising a single-target search model for the single-target search intention and a multiple-target search model for the multiple-target search intention; generating search results for the search query using the selected search intention model; and causing the generated search results for the search query to be displayed on the computing device.

In some example embodiments, the term(s) comprises an identification of a specific user profile stored in a database of an on an online service, and the search intention is determined to be the single-target search intention. In some example embodiments, the term(s) comprises at least one characteristic that is common among multiple user profiles stored in a database of on an online service, and the search intention is determined to be the multiple-target search intention.

In some example embodiments, the determining the search intention for the search query comprises performing one or more natural language processing operations using the term(s) of the search query. In some example embodiments, the determining the search intention for the search query comprises: accessing behavior data of the user stored on a database of an online service, the behavior data comprising a history of search queries submitted by the user and click data indicating corresponding responses of the user to search results of the submitted search queries; and determining the search intention for the search query based at least in part on the accessed behavior data of the user.

In some example embodiments, the operations further comprise: receiving, via the user interface of the computing device, response data indicating a response by the user to the displayed search results; storing the response data according to the selected search intention model; and performing at least one machine learning operation to train the selected search intention model using the stored response data as training data based on the storage of the response data in association with the selected search intention model. In some example embodiments, the operations further comprise: identifying a type of action corresponding to the response indicated by the response data, and assigning a weight to the response data based on the identified type of action, wherein the assigned weight is used in the performing of the at least one machine learning operation to train the selected search intention model using the stored response data as training data. In some example embodiments, the storing of the response data according to the selected search intention model comprises: selecting a data repository from amongst a plurality of distinct data repositories based on the selected search intention model, the plurality of distinct data repositories comprising a single-target model data repository for training the single-target intention model and a multiple-target model data repository for training the multiple target intention model, and storing the response data in the selected data repository. In some example embodiments, the storing of the response data according to the selected search intention model comprises storing the response data in a data repository in association with a tag indicating that the response data is to be used as training data in training the selected search intention model.

In some example embodiments, the generating the search results for the search query comprises: searching a database of candidates based on the term(s) of the search query; identifying a plurality of candidates from the database of candidates based on the searching of the database; generating corresponding scores for each one of the plurality of candidates based on the selected search intention model; ranking the plurality of candidates based on their corresponding scores; and including at least a portion of the plurality of candidates in the generated search results based on the ranking.

In some example embodiments, the generating the search results for the search query comprises: searching a database of candidates based on the at least one term of the search query; identifying a plurality of candidates from the database of candidates based on the searching of the database, generating corresponding scores for each one of the plurality of candidates based on the selected search intention model; ranking the plurality of candidates based on their corresponding scores to generate a first ranking of the plurality of candidates; randomly shuffling a portion of the first ranking of the plurality of candidates to generate a second ranking of the plurality of candidates different from the first ranking, the random shuffling causing at least one of the plurality of candidates that would have been displayed on a first page of the search results based on the first ranking to be replaced in the second ranking with at least one of the plurality of candidates that would not have been displayed on the first page of the search results based on the first ranking; and including at least a portion of the plurality of candidates in the generated search results based on the second ranking.

In some example embodiments, the generating the search results for the search query comprises: searching a database of candidates based on the term(s) of the search query; identifying a plurality of candidates from the database of candidates based on the searching of the database; generating corresponding scores for each one of the plurality of candidates based on the selected search intention model; ranking the plurality of candidates based on their corresponding scores to generate a first ranking of the plurality of candidates; selecting a loss function model from amongst a plurality of loss function models based on the search query, the plurality of loss function models comprising a pointwise loss function model and a pairwise loss function model; generating a second ranking of the plurality of candidates different from the first ranking using the selected loss function model, the generating the second ranking comprising inputting the first ranking of the plurality of candidates into the selected loss function model to generate the second ranking of the plurality of candidates; and including at least a portion of the plurality of candidates in the generated search results based on the second ranking.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

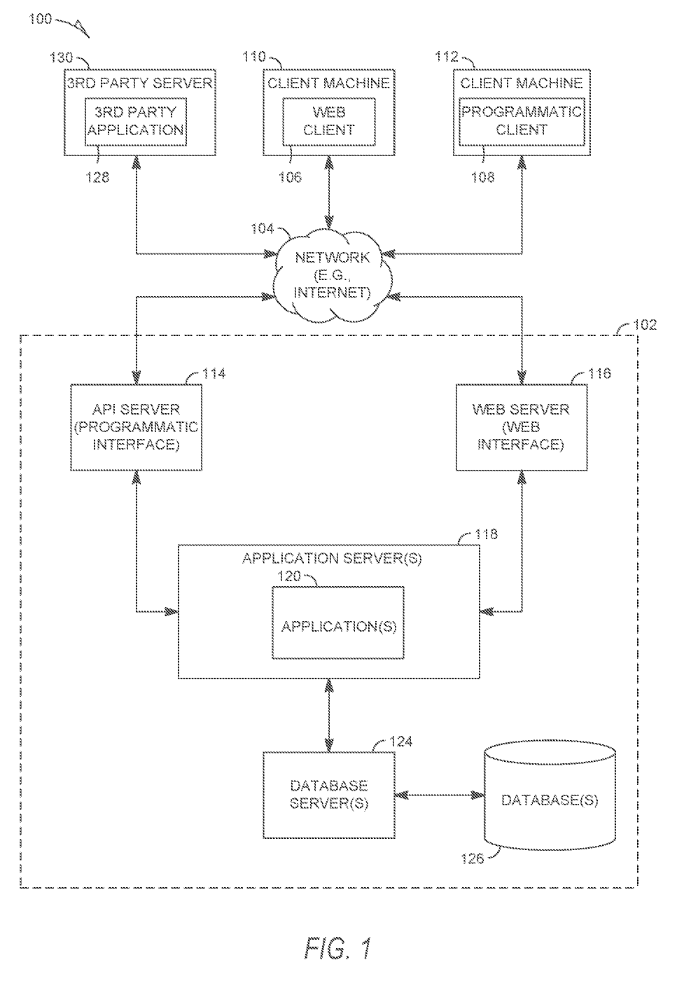

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

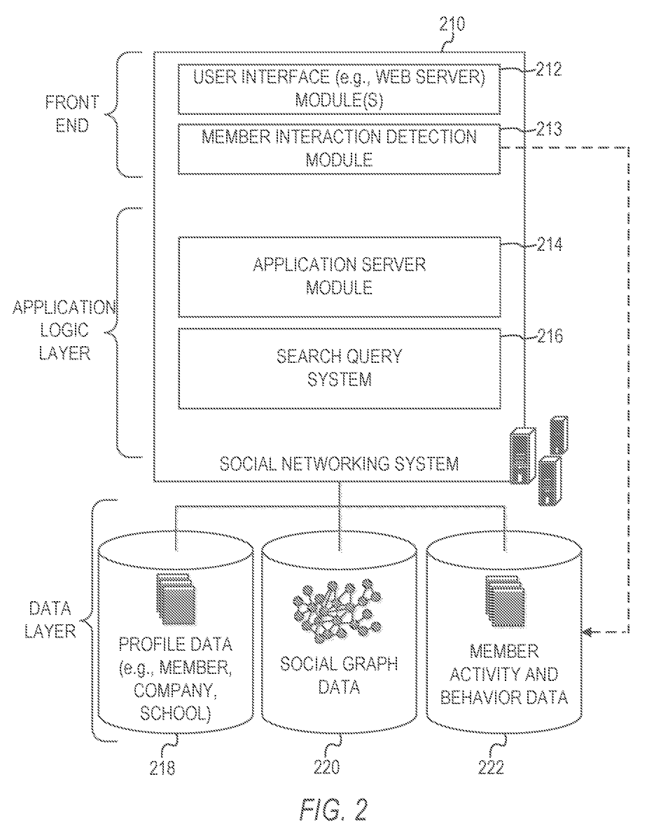

In some embodiments, the networked system 102 may comprise functional components of a social networking service. FIG. 2 is a block diagram showing the functional components of a social networking system 210, including a data processing module referred to herein as a search query system 216, for use in social networking system 210, consistent with some embodiments of the present disclosure. In some embodiments, the search query system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the search query system 216.

As shown in FIG. 2, a data layer may include several databases, such as a database 218 for storing profile data, including both member profile data and profile data for various organizations (e.g., companies, schools, etc.) Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements.

Although the search query system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

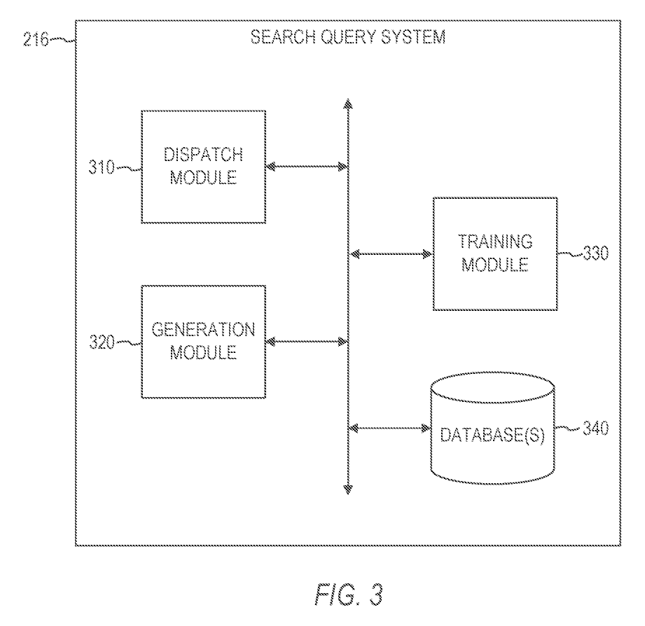

FIG. 3 is a block diagram illustrating components of the search query system 216, in accordance with an example embodiment. In some embodiments, the search query system 216 comprises any combination of one or more of a dispatch module 310, a generation module 320, a training module 330, and one or more database(s) 340. The modules 310, 320, and 330 and the database(s) 340 can reside on a computer system, or other machine, having a memory and at least one processor (not shown). In some embodiments, the modules 310, 320, and 330 and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, as well as the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access social graph data and member activity and behavior data from database(s) 340, as well as exchange information with third party servers 130, client machines 110, 112, and other sources of information.

In some example embodiments, the search query system 216 is configured to address certain biases that hinder other search query systems. One such bias is a search intention bias. When a user performs a search by entering one or more terms as part of a search query, current search query systems fail to take into account the search intention of the user. For example, in one instance, the user may be intending to search for a single specific target, such as by entering the name of a person whom the user wants to find, while in another instance, the user may be intending to search for multiple targets, such as by entering one or more characteristics that are common among a set of people. In the instance of the single-target search intention, the user is intending to navigate to a particular search result (e.g., a user intending to find and connect with an old acquaintance), whereas in the instance of the multiple-target search intention, the user is intending to explore a set of search results that satisfy certain criteria (e.g., a job recruiter searching for potential candidates for an open position). Using the same search model to generate search results for both types of search intention scenarios causes the search results to suffer from a lack of relevance for the particular user that is performing the search.

In some example embodiments, the dispatch module 310 is configured to receive a search query from a computing device of a user. The search query comprises at least one term entered by the user via a user interface of the computing device. The term(s) may be entered using one or more graphical user interface elements, such as by typing the term(s) into a text field and clicking a “Submit” button. However, it is contemplated that the term(s) may be entered by user in other ways as well.

In some example embodiments, the dispatch module 310 is configured to determine a search intention for the search query based on the term(s) of the search query. In determining the search intention for the search query, the dispatch module 310 selects a search intention from a plurality of search intention. In some example embodiments, the dispatch module 310 determines whether the search intention is either a single-target search intention to find a specific single result or a multiple-target search intention to find multiple results having at least one common characteristic. However, it is contemplated that the dispatch module 310 may also select a search intention from among other types of search intentions, as well as from among more than two types of search intentions. In one example embodiment, the term(s) of the search query comprises an identification of a specific user profile stored in a database of an on an online service, and the search intention is determined to be a single-target search intention. In another example embodiment, the term(s) of the search query comprises at least one characteristic that is common among multiple user profiles stored in a database of on an online service, and the search intention is determined to be a multiple-target search intention.

In some example embodiments, the dispatch module 310 is configured to determine the search intention for the search query using any combination of one or more of rules, heuristics, and natural language processing operations using the term(s) of the search query to determine the meaning or classification of the term(s). In some example embodiments, the dispatch module 310 is also configured to determine the search intention for the search query using behavior data of the user who submitted the search query. For example, the dispatch module 310 may access behavior data of the user stored on a database of an online service, such as the database 222 in FIG. 2. In some example embodiments, the behavior data comprises a history of search queries submitted by the user and click data indicating corresponding responses of the user to search results of the submitted search queries. The dispatch module 310 may then determine the search intention for the search query based at least in part on the accessed behavior data of the user. For example, the behavior data of a user may indicate that the user typically submits a search query, and then only selects (e.g., clicks on) one of the search results, suggesting that the user typically is performing a single-target search, which may be used by the dispatch module 310 in its determination of the search intention of search queries subsequently submitted by the user. In another example, the behavior data of a user may indicate that the user typically submits a search query, and then selects (e.g., clicks on) multiple search results, suggesting that the user typically is performing a multiple-target search, which may be used by the dispatch module 310 in its determination of the search intention of search queries subsequently submitted by the user.

In some example embodiments, the dispatch module 310 is configured to select a search intention model for the search query from amongst a plurality of distinct search intention models based on the determined search intention of the search query. The plurality of distinct search intention models may comprise a single-target search model for the single-target search intention and a multiple-target search model for the multiple-target search intention. It is contemplated that the dispatch module 310 may select a search intention model from among other types and other numbers of distinct search intention models as well.

In some example embodiments, the generation module 320 is configured to generate search results for the search query using the selected search intention model, and then cause the generated search results for the search query to be displayed on the computing device of the user. For example, if the dispatch module 310 selected the single-target search model, then the generation module 320 may use the single-target search model in generating the search results for the search query, whereas, if the dispatch module 310 selected the multiple-target search model, then the generation module 320 may use the multiple-target search model in generating the search results for the search query.

In some example embodiments, the generation module 320 is configured to generate the search results for the search query by searching a database of candidates based on the term(s) of the search query. The generation module 320 may then identify a plurality of candidates from the database of candidates based on the searching of the database, such as by identifying candidates having data that matches the term(s) of the search query, and then generate corresponding scores for each one of the plurality of candidates based on the selected search intention model. For example, the single-target search model may score the candidates differently than the multiple-target search model. The generation module 320 may then rank the plurality of candidates based on their corresponding scores, and then select at least a portion of the plurality of candidates to be included in the generated search results based on the ranking. For example, the generation module 320 may include the first twenty-five candidates in the ranking (the top 25 ranked candidates) to include on the first page of search results to be displayed to the user as the search results for the search query submitted by the user.

In some example embodiments, the training module 330 is configured to use the response of the user to the displayed search results for the search query in training the selected search intention model used in generating the search results. For example, the training module 330 may receive, via the user interface of the computing device, response data indicating a response by the user to the displayed search results, and then store the response data according to the selected search intention model. Such response data may include, but is not limited to, click data (e.g., clickstream or click path data) indicating what action the user performed in response to viewing the generated search results, such as clicking to view one of the search results, clicking to navigate to another page without viewing any of the search results, clicking to form an online connection with one of the search results (e.g., clicking to “Connect” with a member profile displayed as one of the search results), and clicking to send an online message to one of the search results. Other types of click data are also within the scope of the present disclosure.

In some example embodiments, the training module 330 is configured to perform at least one machine learning operation to train the selected search intention model using the stored response data as training data based on the storage of the response data in association with the selected search intention model. In this respect, in some example embodiments, the training module 330 only uses response data that resulted from search results generated using a particular search intention model in training that particular search intention model. For example, in some example embodiments, only response data resulting from the use of the single-target search model is used as training data in training the single-target search model, while online response data resulting from the use of the multiple-target search model is used as training data in training the multiple-target search model.

In some example embodiments, the training module 330 is configured to address user behavior bias by weighting each response represented in the training data based on the type of action of that response, with different weights being used for different types of actions. For example, a response of clicking to form an online connection with one of the search results may be assigned a greater weight than a response of clicking to simply view one of the search results. In some example embodiments, the training module 330 is configured to identify a type of action corresponding to the response indicated by the response data, and assign a weight to the response data based on the identified type of action. The assigned weight may then be used in the performing of the machine learning operation(s) used to train the selected search intention model using the stored response data as training data.

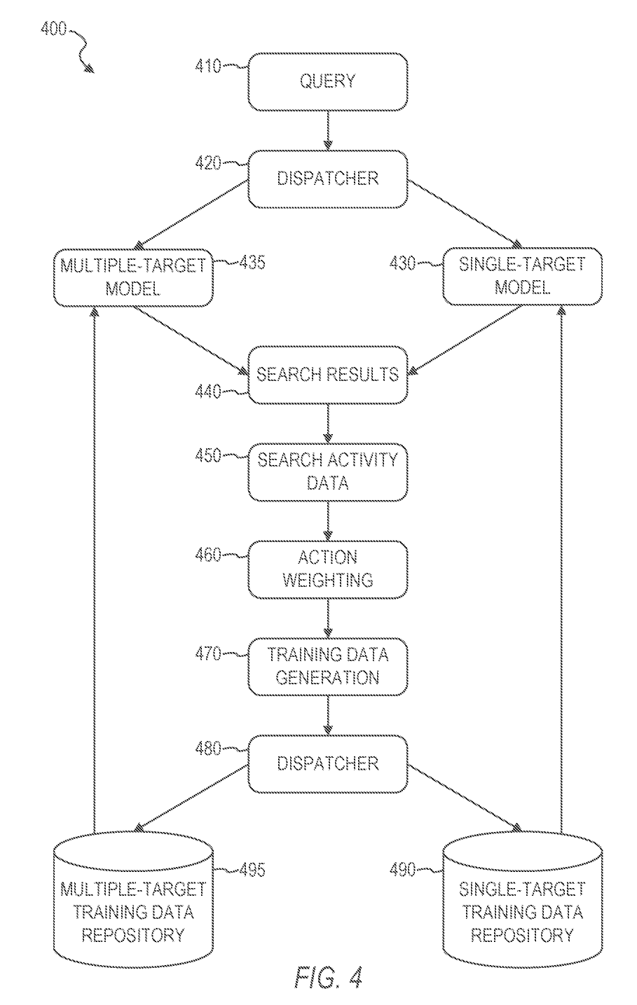

FIG. 4 is a block diagram illustrating a data flow 400, in accordance with an example embodiment. The data flow 400 may be performed or otherwise implemented by the search query system 216 of FIGS. 2-3.

At operation 410, the search query system 216 receives a search query from a computing device of a user. The search query comprises at least one term entered by the user via a user interface of the computing device.

At operation 420, the search query system 216 acts as a dispatcher of the search query, dispatching the search query to the appropriate search intention model. The search query system 216 determines a search intention for the search query based on the term(s) of the search query, selecting a search intention from among a single-target search intention to find a specific single result and a multiple-target search intention to find multiple results having at least one common characteristic. The search query system 216 selects a search intention model for the search query from amongst a single-target search model 430 for the single-target search intention and a multiple-target search model 435 for the multiple-target search intention, and then dispatches the search query to the selected search intention model.

If the search query system 216 determines the search intention for the search query to be a single-target search intention, then the search query system 216 dispatches the search query to the single-target model 430, where the single-target model 430 generates and displays search results 440. If, on the other hand, the search query system 216 determines the search intention for the search query to be a multiple-target search intention, then the search query system 216 dispatches the search query to the multiple-target model 435, where the multiple-target model 435 generates and displays search results 440.

At operation 450, the search query system 216 receives, via the user interface of the computing device, search activity data, such as the response data discussed above, indicating a response by the user to the displayed search results. At operation 460, the search query system 216 performs action weighting on the search activity data, identifying a type of action corresponding to each action in the search activity data, and assigning a weight to each item in the search activity data based on the identified type of action. At operation 470, the search query system 216 generates training data using the weighted search activity data.

At operation 480, the search query system 216 once again acts as a dispatcher, selecting from amongst a plurality of data repositories in which to store the generated training data based on the search intention model used to generate the search results from which the search activity data of the training data resulted. For example, the search query system 216 may select between a single-target training data repository 490 for training data resulting from the use of the single-target model 430 and a multiple-target training data repository 495 for training data resulting from the user of the multiple-target model 435. The search query system 216 may then selectively use the training data in a particular training data repository in training a particular search intention model, using only the training data from the single-target training data repository 490 as training data in one or more machine learning operation to train the single-target model 430, and using only the training data from the multiple-target training data repository 495 as training data in one or more machine learning operation to train the multiple-target model 435.

In some example embodiments, as an alternative to storing training data in different training data repositories based on the particular search intention model that was used in generating the search results from which the training data resulted, the search query system 216 may store the training data in a data repository in association with a tag (or some other identifier) indicating that the training data is to be used as training data in training the particular search intention model that was used in generating the search results from which the training data resulted. The search query system 216 may then select only the training data tagged for a particular search intention model when retrieving training data to train that particular search intention model. In this respect, a single training data repository may be used for storing all of the training data for all of the different search intention models, while still enabling the selective use of particular training data for training the particular search intention model that was used in generating the search results from which the particular training data resulted.

Referring back to FIG. 3, in some example embodiments, the generation module 320 is configured to address ranking bias by randomly shuffling a portion of the initial ranking of the search results before displaying the search results to the user. The use of a particular search intention model produces search results in which a top N number (e.g., top twenty-five) of search result candidates are displayed on the first page of the search results, and then a next N number of search results are displayed on the next page of the search results, and so on and so forth. Since the search results displayed on the first page are more likely to be viewed by the user then the search results on subsequent pages, the search results displayed on the first page are more likely to receive positive response data, such as being selected to be viewed or otherwise acted upon. As a result, the response data used to train the search intention model may have a ranking bias, in that the search results on the subsequent pages are not given a proper chance to be considered and acted upon by the user, even though the search results on the subsequent pages might be more relevant to the search query than the search results on the first page. Therefore, the resulting training data may incorrectly indicate that the search results on the subsequent pages were not as relevant to the search query as the search results on the first page.

In order to address this ranking bias, the generation module 320 may take the initial ranking of search result candidates, and replace a certain portion of the top N ranked candidates with a certain portion of lower-ranked candidates before displaying the top N ranked candidates to the user. For example, the generation module 320 may generate a first ranking of ten candidates A, B, C, D, E, F, G, H, I and J as follows:

| Rank | Candidate | Score |
|---|---|---|
| 1 | A | 99 |
| 2 | B | 98 |
| 3 | C | 98 |
| 4 | D | 93 |
| 5 | E | 92 |
| 6 | F | 90 |
| 7 | G | 89 |
| 8 | H | 86 |
| 9 | I | 81 |
| 10 | J | 72 |

with candidates A, B, C, D, and E ranked 1-5 to be displayed on the first page of search results, and candidates F, G, H, I, and J ranked 6-10 to be displayed on the second page of search results. In this example, the generation module 320 may then replace candidate E ranked 5th with candidate F ranked 6^{th}, thereby generating a second ranking as follows:

| Rank | Candidate | Score |
|---|---|---|
| 1 | A | 99 |
| 2 | B | 98 |
| 3 | C | 98 |
| 4 | D | 93 |
| 5 | F | 90 |
| 6 | E | 92 |
| 7 | G | 89 |
| 8 | H | 86 |
| 9 | I | 81 |
| 10 | J | 72 |

with candidates A, B, C, D, and F ranked 1-5 to be displayed on the first page of search results, and candidates E, G, H, I, and J ranked 6-10 to be displayed on the second page of search results. The generation module 320 may use this shuffling approach in a certain percentage (e.g., 2%) of search queries, thereby helping to mitigate the ranking bias in the training data used to train the search intention models.

In some example embodiments, the generation module 320 is configured to search a database of search result candidates based on the term(s) of the search query, identify a plurality of candidates from the database of candidates based on the searching of the database, generate corresponding scores for each one of the plurality of candidates based on the selected search intention model, and rank the plurality of candidates based on their corresponding scores to generate a first ranking of the plurality of candidates. In some example embodiments, the generation module 320 is further configured to shuffle a portion of the first ranking of the plurality of candidates to generate a second ranking of the plurality of candidates different from the first ranking, where the shuffling causes at least one of the plurality of candidates that would have been displayed on a first page of the search results based on the first ranking to be replaced in the second ranking with at least one of the plurality of candidates that would not have been displayed on the first page of the search results based on the first ranking. In some example embodiments, the shuffling of the candidates is random, such that the determination of which candidate(s) is replaced with which candidate is randomly determined by the generation module 320, while in other example embodiments, the generation module 320 is configured to select a particular portion of the top N ranked search result candidates to be replaced with a particular portion of the other ranked search results candidates (e.g., in instances in which the shuffling is performed, candidates ranked 20-25 are always replaced with candidates ranked 26-30).

In some example embodiments, the generation module 320 is also configured to address a search model bias by using a particular loss function model to boost the initial ranking of search result candidates based on the search query. In some example embodiments, the generation module 320 is configured to search a database of candidates based on the term(s) of the search query, identify a plurality of candidates from the database of candidates based on the searching of the database, generate corresponding scores for each one of the plurality of candidates based on the selected search intention model, and rank the plurality of candidates based on their corresponding scores to generate a first ranking of the plurality of candidates. In some example embodiments, the generation module 320 is further configured to select a loss function model from amongst a plurality of loss function models based on the search query. The plurality of loss function models may comprise a pointwise loss function model and a pairwise loss function model. A pointwise loss function model is configured to consider that each training data point is independent from each other, while a pairwise loss function model is configured to consider that training data from the same search query session are more related and comparable than training data from separate search query sessions and that additional user preference information can be obtained from such training data from the same session.

The generation module 320 may be configured to base the selection of the particular loss function model on the term(s) of the search query, using rules or heuristics. In some example embodiments, the generation module 320 bases the selection of the particular loss function model on the determined search intention of the search query. For example, the generation module 320 may be configured to select a pointwise loss function model for a search query based on a determination that the search intention for the search query is a single-target search intention, whereas the generation module 320 may be configured to select a pairwise loss function model for a search query based on a determination that the search intention for the search query is a multiple-target search intention. Other configurations of selecting the particular loss function model are also within the scope of the present disclosure.

In some example embodiments, the generation module 320 is configured to generate a second ranking of the plurality of candidates different from the first ranking using the selected loss function model, where the first ranking of the plurality of candidates is served as input into the selected loss function model to generate the second ranking of the plurality of candidates. The generation module 320 may then include at least a portion of the plurality of candidates in the generated search results based on the second ranking, rather than using the first ranking.

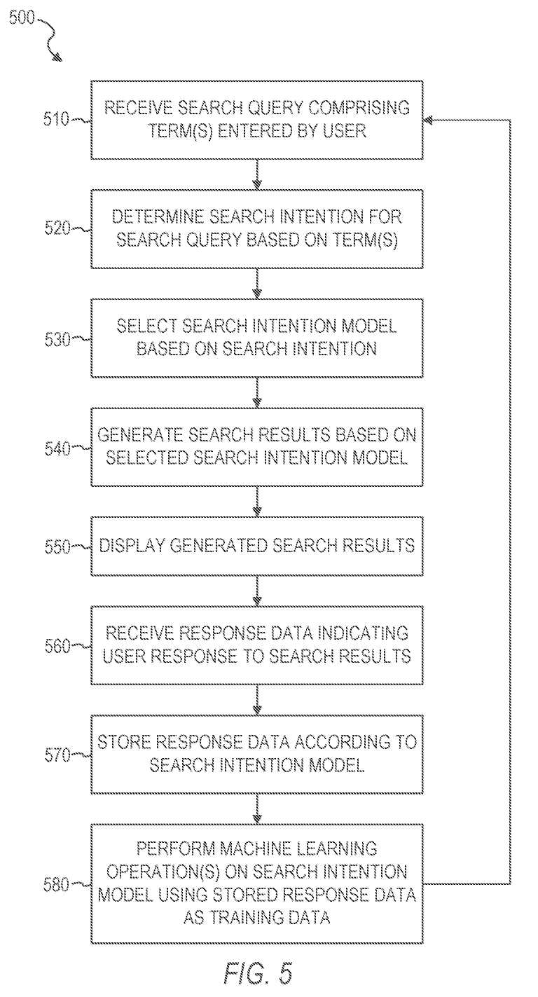

FIG. 5 is a flowchart illustrating a method 500 of implementing a search query dispatcher using machine learning, in accordance with an example embodiment. The method 500 can be performed by processing logic that can comprise hardware (e.g., circuitry, dedicated logic, programmable logic, microcode, etc.), software (e.g., instructions run on a processing device), or a combination thereof. In one implementation, the method 500 is performed by the search query system 216 of FIGS. 2-3, or any combination of one or more of its modules, as described above.

At operation 510, the search query system 216 receives a search query from a computing device of a user. The search query may comprise at least one term entered by the user via a user interface of the computing device. At operation 520, the search query system 216 determines a search intention for the search query based on the term(s) of the search query. The search intention may be determined to be either a single-target search intention to find a specific single result or a multiple-target search intention to find multiple results having at least one common characteristic. In some example embodiments, the term(s) comprises an identification of a specific user profile stored in a database of an on an online service, and the search intention is determined to be the single-target search intention. In some example embodiments, the term(s) comprises at least one characteristic that is common among multiple user profiles stored in a database of on an online service, and the search intention is determined to be the multiple-target search intention. However, it is contemplated that other configurations are also within the scope of the present disclosure.

At operation 530, the search query system 216 selects a search intention model for the search query from amongst a plurality of distinct search intention models based on the determined search intention of the search query. The plurality of distinct search intention models may comprise a single-target search model for the single-target search intention and a multiple-target search model for the multiple-target search intention.

At operation 540, the search query system 216 generates search results for the search query using the selected search intention model. At operation 550, the search query system 216 causes the generated search results for the search query to be displayed on the computing device. At operation 560, the search query system 216 receives, via the user interface of the computing device, response data indicating a response by the user to the displayed search results

At operation 570, the search query system 216 stores the response data according to the selected search intention model In some example embodiments, the storing of the response data according to the selected search intention model comprises selecting a data repository from amongst a plurality of distinct data repositories based on the selected search intention model. The plurality of distinct data repositories may comprise a single-target model data repository for training the single-target intention model and a multiple-target model data repository for training the multiple target intention model. The search query system 216 may store the response data in the selected data repository. Alternatively, in some example embodiments, the storing of the response data according to the selected search intention model comprises storing the response data in a data repository in association with a tag (or other identifier) indicating that the response data is to be used as training data in training the selected search intention model. At operation 580, the search query system 216 performs at least one machine learning operation to train the selected search intention model using the stored response data as training data based on the storage of the response data in association with the selected search intention model.

It is contemplated that any of the other features described within the present disclosure can be incorporated into the method 500.

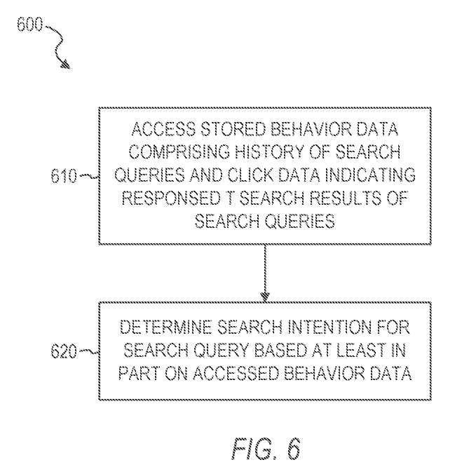

FIG. 6 is a flowchart illustrating a method 600 of determining a search intention for a search query (such as the determining of the search intention at operation 520 in FIG. 5), in accordance with an example embodiment. The method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the search query system 216 of FIGS. 2-3, or any combination of one or more of its modules, as described above.

At operation 610, the search query system 216 accesses behavior data of the user stored on a database of an online service. The behavior data may comprise a history of search queries submitted by the user and click data indicating corresponding responses of the user to search results of the submitted search queries. At operation 620, the search query system 216 determines the search intention for the search query based at least in part on the accessed behavior data of the user.

It is contemplated that any of the other features described within the present disclosure can be incorporated into the method 600.

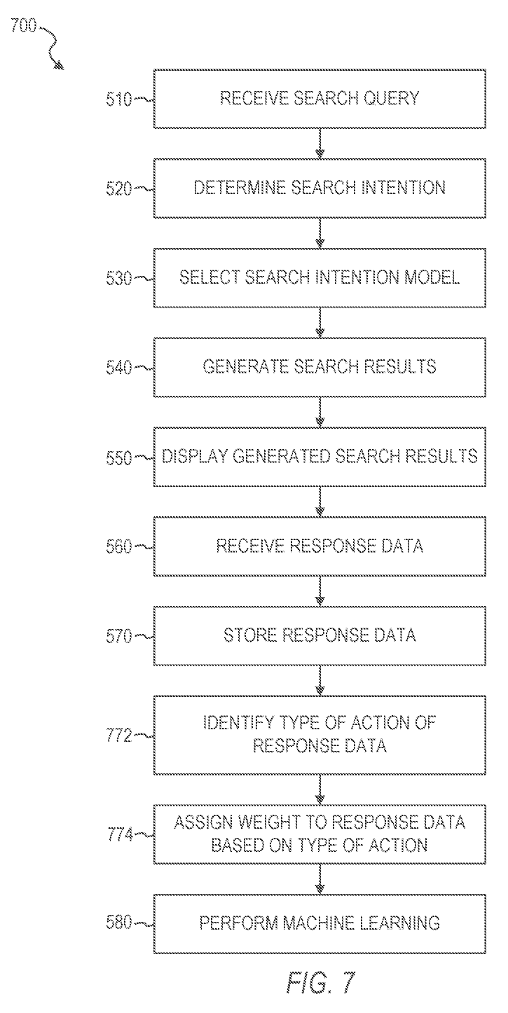

FIG. 7 is a flowchart illustrating another method 700 of implementing a search query dispatcher using machine learning, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the search query system 216 of FIGS. 2-3, or any combination of one or more of its modules, as described above.

The method 700 comprises operations 772 and 774, which may be performed between operations 570 and 580 of the method 500 in FIG. 5. At operation 772, the search query system 216 identifies a type of action corresponding to the response indicated by the response data stored at operation 570. At operation 774, the search query system 216 assigns a weight to the response data based on the identified type of action. In some example embodiments, the assigned weight is used in the performing of the machine learning operation(s) to train the selected search intention model using the stored response data as training data at operation 580.

It is contemplated that any of the other features described within the present disclosure can be incorporated into the method 700.

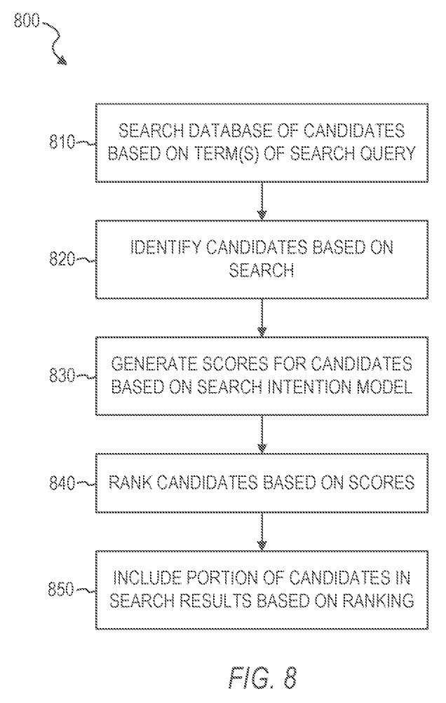

FIG. 8 is a flowchart illustrating a method 800 of generating search results for a search query (such as the generating of search results at operation 540 in FIG. 5), in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the search query system 216 of FIGS. 2-3, or any combination of one or more of its modules, as described above.

At operation 810, the search query system 216 searches a database of candidates based on the term(s) of the search query. At operation 820, the search query system 216 identifies a plurality of candidates from the database of candidates based on the searching of the database. At operation 830, the search query system 216 generates corresponding scores for each one of the plurality of candidates based on the selected search intention model. At operation 840, the search query system 216 ranks die plurality of candidates based on their corresponding scores. At operation 850, the search query system 216 includes at least a portion of the plurality of candidates in the generated search results based on the ranking.

It is contemplated that any of the other features described within the present disclosure can be incorporated into the method 800.

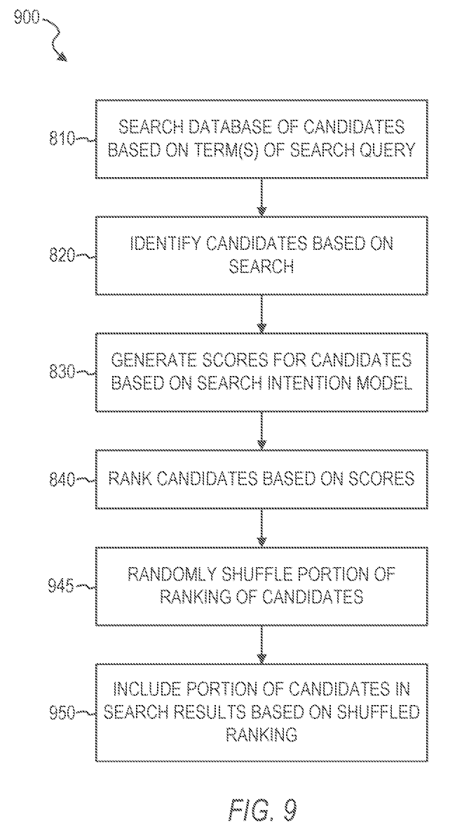

FIG. 9 is a flowchart illustrating another method 900 of generating search results for a search query, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the search query system 216 of FIGS. 2-3, or any combination of one or more of its modules, as described above.

The method 900 comprises operations 945 and 950, which may be performed after operation 840 of the method 800 in FIG. 8. At operation 945, the search query system 216 randomly shuffles a portion of the first ranking of the plurality of candidates, which was generated at operation 840, to generate a second ranking of the plurality of candidates different from the first ranking. In some example embodiments, the random shuffling causes at least one of the plurality of candidates that would have been displayed on a first page of the search results based on the first ranking to be replaced in the second ranking with at least one of the plurality of candidates that would not have been displayed on the first page of the search results based on the first ranking. At operation 950, the search query system 216 includes at least a portion of the plurality of candidates in the generated search results based on the second ranking.

It is contemplated that any of the other features described within the present disclosure can be incorporated into the method 900.

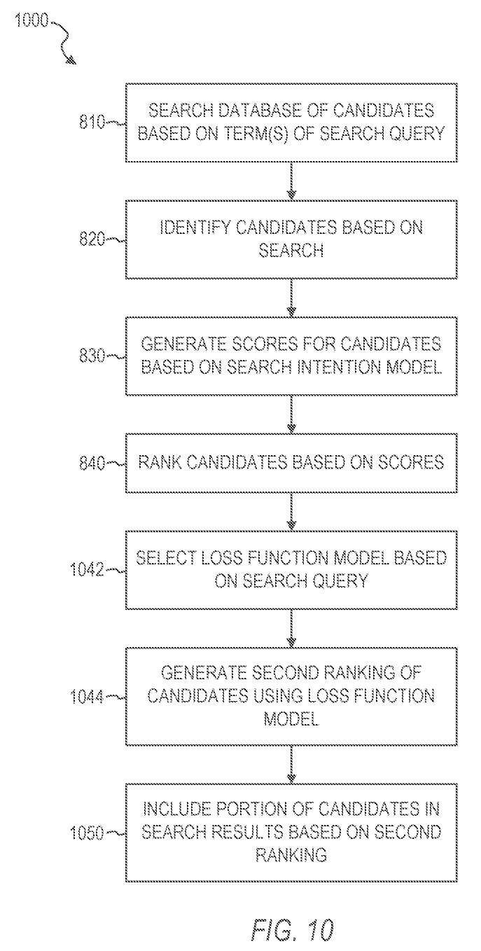

FIG. 10 is a flowchart illustrating yet another method 1000 of generating search results for a search query, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the search query system 216 of FIGS. 2-3, or any combination of one or more of its modules, as described above.

The method 1000 comprises operations 1042, 1044, and 1050, which may be performed after operation 840 of the method 800 in FIG. 8.

At operation 1042, the search query system 216 selects a loss function model from amongst a plurality of loss function models based on the search query. In some example embodiments, the plurality of loss function models comprises a pointwise loss function model and a pairwise loss function model. At operation 1044, the search query system 216 generates a second ranking of the plurality of candidates different from the first ranking (generated at operation 840) using the selected loss function model. In some example embodiments, the generating of the second ranking comprises inputting the first ranking of the plurality of candidates into the selected loss function model to generate the second ranking of the plurality of candidates. At operation 1050, the search query system 216 includes at least a portion of the plurality of candidates in the generated search results based on the second ranking.

It is contemplated that any of the other features described within the present disclosure can be incorporated into the method 1000.

### Example Mobile Device

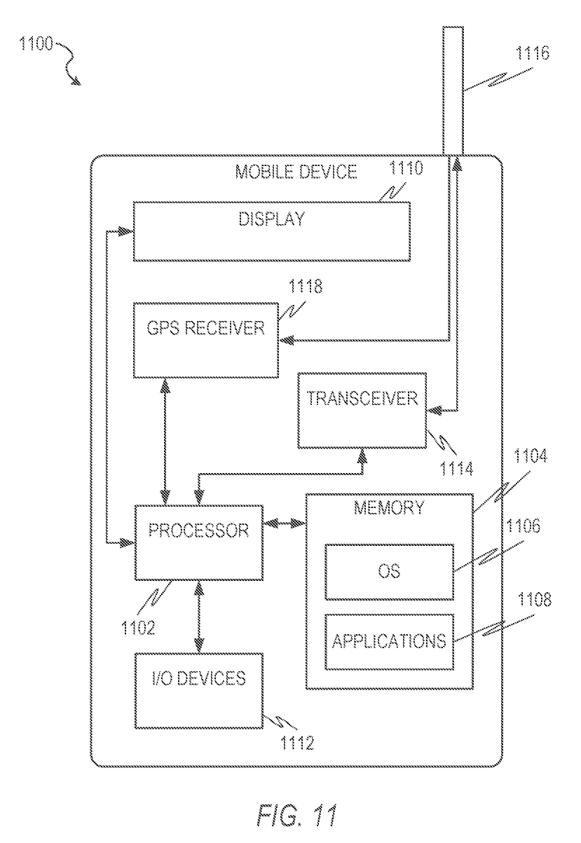

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product. e.g., a computer program tangibly embodied in an information carrier; e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

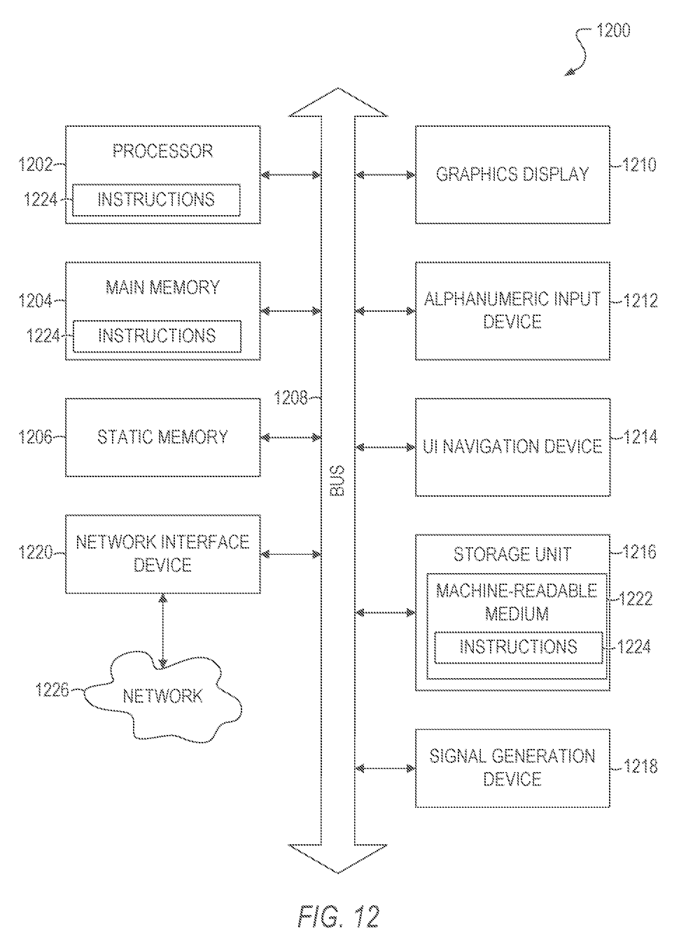

FIG. 12 is a block diagram of an example computer system 1200 on which methodologies described herein may be executed, in accordance with an example embodiment In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a graphics display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a storage unit 1216, a signal generation device 1218 (e.g., a speaker) and a network interface device 1220.

### Machine-Readable Medium

The storage unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions (e.g., instructions 1224) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks) The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving, by a computer system having at least one memory and at least one hardware processor, a search query from a computing device of a user, the search query comprising at least one term entered by the user via a user interface of the computing device;
determining, by the computer system, a search intention for the search query based on the at least one term of the search query, the determining comprising determining the search intention to be either a single-target search intention to find a specific single result or multiple-target search intention to find multiple results having at least one common characteristic;
selecting, by the computer system, a search intention model for the search query from amongst a plurality of distinct search intention models based on the determined search intention of the search query, the plurality of distinct search intention models comprising a single-target search model for the single-target search intention and a multiple-target search model for the multiple-target search intention;
generating, by the computer system, search results for the search query using the selected search intention model; and
causing, by the computer system, the generated search results for the search query to be displayed on the computing device.

2. The computer-implemented method of claim 1, wherein the at least one term comprises an identification of a specific user profile stored in a database of an on an online service, and the search intention is determined to be the single-target search intention.

3. The computer-implemented method of claim 1, wherein the at least one term comprises at least one characteristic that is common among multiple user profiles stored in a database of on an online service, and the search intention is determined to be the multiple-target search intention.

4. The computer-implemented method of claim 1, wherein the determining the search intention for the search query comprises performing one or more natural language processing operations using the at least one term of the search query.

5. The computer-implemented method of claim 1, wherein the determining the search intention for the search query comprises:
accessing behavior data of the user stored on a database of an online service, the behavior data comprising a history of search queries submitted by the user and click data indicating corresponding responses of the user to search results of the submitted search queries, and
determining the search intention for the search query based at least in part on the accessed behavior data of the user.

6. The computer-implemented method of claim 1, further comprising:
receiving, by the computer system via the user interface of the computing device, response data indicating a response by the user to the displayed search results;
storing, by the computer system, the response data according to the selected search intention model; and
performing, by the computer system, at least one machine learning operation to train the selected search intention model using the stored response data as training data based on the storage of the response data in association with the selected search intention model.

7. The computer-implemented method of claim 6, further comprising:
identifying, by the computer system, a type of action corresponding to the response indicated by the response data; and
assigning, by the computer system, a weight to the response data based on the identified type of action, wherein the assigned weight is used in the performing of the at least one machine learning operation to train the selected search intention model using the stored response data as training data.

8. The computer-implemented method of claim 6, wherein the storing of the response data according to the selected search intention model comprises:
selecting a data repository from amongst a plurality of distinct data repositories based on the selected search intention model, the plurality of distinct data repositories comprising a single-target model data repository for training the single-target intention model and a multiple-target model data repository for training the multiple target intention model; and
storing the response data in the selected data repository.

9. The computer-implemented method of claim 6, wherein the storing of the response data according to the selected search intention model comprises storing the response data in a data repository in association with a tag indicating that the response data is to be used as training data in training the selected search intention model.

10. The computer-implemented method of claim 1, wherein the generating the search results for the search query comprises:
searching a database of candidates based on the at least one term of the search query;
identifying a plurality of candidates from the database of candidates based on the searching of the database;
generating corresponding scores for each one of the plurality of candidates based on the selected search intention model;
ranking the plurality of candidates based on their corresponding scores; and
including at least a portion of the plurality of candidates in the generated search results based on the ranking.

11. The computer-implemented method of claim 1, wherein the generating the search results for the search query comprises:
searching a database of candidates based on the at least one term of the search query;
identifying a plurality of candidates from the database of candidates based on the searching of the database;
generating corresponding scores for each one of the plurality of candidates based on the selected search intention model;
ranking the plurality of candidates based on their corresponding scores to generate a first ranking of the plurality of candidates;
randomly shuffling a portion of the first ranking of the plurality of candidates to generate a second ranking of the plurality of candidates different from the first ranking, the random shuffling causing at least one of the plurality of candidates that would have been displayed on a first page of the search results based on the first ranking to be replaced in the second ranking with at least one of the plurality of candidates that would not have been displayed on the first page of the search results based on the first ranking; and
including at least a portion of the plurality of candidates in the generated search results based on the second ranking.

12. The computer-implemented method of claim 1, wherein the generating the search results for the search query comprises:
searching a database of candidates based on the at least one term of the search query;
identifying a plurality of candidates from the database of candidates based on the searching of the database;
generating corresponding scores for each one of the plurality of candidates based on the selected search intention model;
ranking the plurality of candidates based on their corresponding scores to generate a first ranking of the plurality of candidates;
selecting a loss function model from amongst a plurality of loss function models based on the search query, the plurality of loss function models comprising a pointwise loss function model and a pairwise loss function model;
generating a second ranking of the plurality of candidates different from the first ranking using the selected loss function model, the generating the second ranking comprising inputting the first ranking of the plurality of candidates into the selected loss function model to generate the second ranking of the plurality of candidates; and
including at least a portion of the plurality of candidates in the generated search results based on the second ranking.

13. A system comprising:
at least one hardware processor; and
a non-transitory machine-readable medium embodying a set of instructions that, when executed by the at least one hardware processor, cause the at least one processor to perform operations, the operations comprising:
receiving a search query from a computing device of a user, the search query comprising at least one term entered by the user via a user interface of the computing device;
determining a search intention for the search query based on the at least one term of the search query, the determining comprising determining the search intention to be either a single-target search intention to find a specific single result or multiple-target search intention to find multiple results having at least one common characteristic;
selecting a search intention model for the search query from amongst a plurality of distinct search intention models based on the determined search intention of the search query, the plurality of distinct search intention models comprising a single-target search model for the single-target search intention and a multiple-target search model for the multiple-target search intention;
generating search results for the search query using the selected search intention model; and
causing the generated search results for the search query to be displayed on the computing device.

14. The system of claim 13, wherein the at least one term comprises an identification of a specific user profile stored in a database of an on an online service, and the search intention is determined to be the single-target search intention.

15. The system of claim 13, wherein the at least one term comprises at least one characteristic that is common among multiple user profiles stored in a database of on an online service, and the search intention is determined to be the multiple-target search intention.

16. The system of claim 13, wherein the operations further comprise:
receiving, via the user interface of the computing device, response data indicating a response by the user to the displayed search results;
storing the response data according to the selected search intention model; and
performing at least one machine learning operation to train the selected search intention model using the stored response data as training data based on the storage of the response data in association with the selected search intention model.

17. The system of claim 16, wherein the operations further comprise:
identifying a type of action corresponding to the response indicated by the response data; and
assigning a weight to the response data based on the identified type of action, wherein the assigned weight is used in the performing of the at least one machine learning operation to train the selected search intention model using the stored response data as training data.

18. The system of claim 13, wherein the generating the search results for the search query comprises:
searching a database of candidates based on the at least one term of the search query;
identifying a plurality of candidates from the database of candidates based on the searching of the database;
generating corresponding scores for each one of the plurality of candidates based on the selected search intention model;
ranking the plurality of candidates based on their corresponding scores to generate a first ranking of the plurality of candidates;
randomly shuffling a portion of the first ranking of the plurality of candidates to generate a second ranking of the plurality of candidates different from the first ranking, the random shuffling causing at least one of the plurality of candidates that would have been displayed on a first page of the search results based on the first ranking to be replaced in the second ranking with at least one of the plurality of candidates that would not have been displayed on the first page of the search results based on the first ranking; and
including at least a portion of the plurality of candidates in the generated search results based on the second ranking.

19. The system of claim 13, wherein the generating the search results for the search query comprises:
searching a database of candidates based on the at least one term of the search query;
identifying a plurality of candidates from the database of candidates based on the searching of the database;
generating corresponding scores for each one of the plurality of candidates based on the selected search intention model;
ranking the plurality of candidates based on their corresponding scores to generate a first ranking of the plurality of candidates;
selecting a loss function model from amongst a plurality of loss function models based on the search query, the plurality of loss function models comprising a pointwise loss function model and a pairwise loss function model;
generating a second ranking of the plurality of candidates different from the first ranking using the selected loss function model, the generating the second ranking comprising inputting the first ranking of the plurality of candidates into the selected loss function model to generate the second ranking of the plurality of candidates; and
including at least a portion of the plurality of candidates in the generated search results based on the second ranking.

20. A non-transitory machine-readable medium embodying a set of instructions that, when executed by at least one hardware processor, cause the processor to perform operations, the operations comprising:
receiving a search query from a computing device of a user, the search query comprising at least one term entered by the user via a user interface of the computing device;
determining a search intention for the search query based on the at least one term of the search query, the determining comprising determining the search intention to be either a single-target search intention to find a specific single result or multiple-target search intention to find multiple results having at least one common characteristic;
selecting a search intention model for the search query from amongst a plurality of distinct search intention models based on the determined search intention of the search query, the plurality of distinct search intention models comprising a single-target search model for the single-target search intention and a multiple-target search model for the multiple-target search intention;
generating search results for the search query using the selected search intention model; and
causing the generated search results for the search query to be displayed on the computing device.
